(19) United States
(12) Patent Application Publication
(10) Pub. No.: US 2026/0313050 A1
(43) Pub. Date: Oct. 8, 2026

(54) System and Method for Arbitrating Lock Screen Surface Access Among Competing Vendor Applications on a Mobile Device

(71) Applicant: T-Mobile Innovations LLC, Overland Park, KS (US)

(72) Inventor: Billy Gene McCracken, JR., Lenexa, KS (US)

(21) Appl. No.: 19/636,741

(22) Filed: Apr. 1, 2026

Related U.S. Application Data
(60) Provisional application No. 63/783,919, filed on Apr. 4, 2025.

(51) Int. Cl. H04M 1/72463; H04W 4/12

(52) U.S. Cl. CPC H04M 1/724634; H04W 4/12

(57) ABSTRACT

A method comprising receiving, by a second vendor application, a request message broadcast by a first vendor application executing on the mobile device, transmitting, by the second vendor application, a blocked message to the first vendor application upon a determination that the second vendor application currently holds the lock screen surface of the mobile device, and transmitting, by the second vendor application, a completion message to the first vendor application upon the second vendor application relinquishing the lock screen surface of the mobile device. The first vendor application rebroadcasts the request message upon receipt of the completion message and to present content on the lock screen surface of the mobile device upon expiration of a threshold time period following the rebroadcasting of the request message.

### CROSS-REFERENCE TO RELATED APPLICATIONS

This application claims priority to U.S. Provisional Patent Application No. 63/783,919, filed Apr. 4, 2025, and entitled "Methods and Systems for Dynamically Managing Device Screen Content and Widgets," the contents of which are incorporated herein by reference in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile devices may present distinct content across multiple screen states, including a lock screen displayed prior to user authentication, a transition surface displayed during the unlock event, and a home screen displayed upon completion of authentication. These surfaces may display different content simultaneously. On operator-provisioned devices, multiple independent applications may attempt to access shared engagement surfaces such as the lock and unlock screens.

### SUMMARY

In an embodiment, a system for dynamically managing lock screen content and widget display on a mobile device is disclosed. The system comprises one or more memories, one or more processors coupled to the one or more memories, an orchestration application stored at the one or more memories which, when executed by the one or more processors, causes the orchestration application to be configured to receive a registration request from each of a plurality of vendor applications seeking access to a lock screen surface of a mobile device, register each of the plurality of vendor applications in a vendor registry stored in a data store accessible by the orchestration application, receive a render request from a requesting vendor application of the plurality of vendor applications, evaluate a state of the lock screen surface of the mobile device and one or more arbitration policies to determine whether to render content from the requesting vendor application on the lock screen surface of the mobile device, transmit a grant message, a deny message, or a defer message to the requesting vendor application based on the evaluation of the state of the lock screen surface and the one or more arbitration policies, receive a release message from the requesting vendor application upon completion of a lock screen session at the mobile device, and transmit a broadcast message to one or more vendor applications of the plurality of vendor applications upon occurrence of an unlock event at the mobile device. The broadcast message comprises metadata describing a content type presented during the lock screen session or during the unlock event. The plurality of vendor applications stored at the one or more memories which, when executed by the one or more processors, causes a vendor application of the plurality of vendor applications to be configured to receive the broadcast message from the orchestration application, evaluate a widget engagement score based at least in part on the metadata included in the broadcast message and one or more widget policies, and selectively present a widget associated with the vendor application on a home screen of the mobile device or suppress the widget based on the widget engagement score.

In another embodiment, a method for managing competing access to a lock screen surface of a mobile device is disclosed. The method comprises broadcasting, by a first vendor application executing on a mobile device, a request message to one or more other vendor applications executing on the mobile device, the request message indicates an intent by the first vendor application to occupy the lock screen surface of the mobile device, receiving, by a second vendor application executing on the mobile device, the request message, determining, by the second vendor application, that the second vendor application currently holds the lock screen surface of the mobile device, transmitting, by the second vendor application, a blocked message to the first vendor application when the second vendor application currently holds the lock screen surface of the mobile device, transmitting, by the second vendor application, a completion message to the first vendor application upon the second vendor application relinquishing the lock screen surface of the mobile device, rebroadcasting, by the first vendor application, the request message to the one or more other vendor applications upon receipt of the completion message, and presenting, by the first vendor application, content on the lock screen surface of the mobile device upon expiration of a threshold time period following the rebroadcasting of the request message.

In yet another embodiment, a non-transitory computer-readable medium is disclosed. The non-transitory computer-readable medium comprises instructions that, when executed by one or more processors, cause the one or more processors to receive, by a second vendor application executing on a mobile device, a request message broadcast by a first vendor application executing on the mobile device, wherein the request message indicates an intent by the first vendor application to occupy a lock screen surface of the mobile device, transmit, by the second vendor application, a blocked message to the first vendor application upon a determination that the second vendor application currently holds the lock screen surface of the mobile device, and transmit, by the second vendor application, a completion message to the first vendor application upon the second vendor application relinquishing the lock screen surface of the mobile device. The first vendor application is configured to rebroadcast the request message upon receipt of the completion message and to present content on the lock screen surface of the mobile device upon expiration of a threshold time period following the rebroadcasting of the request message, is disclosed.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system for dynamically managing lock screen content and widget display on a mobile device according to various embodiments of the disclosure.

FIG. 2 is a message sequence diagram illustrating a method for managing competing access to a lock screen surface of a mobile device among a plurality of vendor applications according to various embodiments of the disclosure.

FIG. 3 is a message sequence diagram illustrating a method for orchestrating vendor application access to a lock screen surface and broadcasting context information upon an unlock event in the system of FIG. 1 according to various embodiments of the disclosure.

FIG. 4 is a message sequence diagram illustrating a method for evaluating widget engagement scores and selectively presenting widgets on a home screen of a mobile device in the system of FIG. 1 according to various embodiments of the disclosure.

FIG. 5 is a flowchart illustrating a method for managing competing access to a lock screen surface of a mobile device according to various embodiments of the present disclosure.

FIG. 6 is a flowchart illustrating a method for dynamically managing lock screen content and widget display on a mobile device according to various embodiments of the present disclosure.

FIG. 7 is a block diagram of a computer system implemented within the system of FIG. 1 according to various embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Modern mobile devices may host multiple vendor applications that independently seek to present content on shared engagement surfaces, such as the lock screen surface of a mobile device. Each vendor application may independently attempt to retrieve updated content from remote endpoints, prepare renderable payloads, and present the content on the lock screen surface at the moment of a lock or unlock event. When multiple vendor applications initiate these operations simultaneously without a governing coordination mechanism, the mobile device may experience redundant network retrieval of media content and competing background process activations that increase processing utilization and network bandwidth overhead. These competing behaviors may also produce conditions in which multiple vendor applications simultaneously issue network requests to retrieve updated content without any mechanism to coordinate timing or priority. Stage collisions may also arise, in which two or more vendor applications prepare renderable content without a mechanism to determine which application will ultimately occupy the lock screen surface, resulting in wasted processing resource consumption and degraded lock screen rendering performance. The mobile device operating system may respond to these conditions by throttling or terminating application processes, introducing unpredictable rendering latency at the moment of user interaction and compounding the processing overhead already generated by the competing vendor applications.

More generally, a shared engagement surface may refer to any display surface or interaction context on a computing device to which multiple independent applications may simultaneously seek to publish content or claim exclusive or priority access. A shared engagement surface may be characterized by: a defined activation trigger (such as a device state transition, a user interaction event, or an external signal) that renders the surface available for content presentation; a finite display capacity that may accommodate only one or a limited number of concurrent content providers at a given time; and a period of elevated user attention associated with the activation event, making the surface disproportionately valuable to vendor applications competing for user engagement. Examples of shared engagement surfaces may include lock screens, unlock transition surfaces, ambient display overlays, notification shade regions, always-on display panels, incoming call screens, media playback overlays, and heads-up notification zones. Each of these surfaces may share the structural characteristic that multiple vendor applications independently seek access to a single finite presentation context at a moment of concentrated user attention.

The present disclosure addresses the aforementioned technical problems in the technical field of lock screen surface arbitration and inter-application coordination on mobile devices by providing a system and method in which competing vendor applications may cooperate through a governed arbitration protocol to acquire ownership of the lock screen surface. In some embodiments, arbitration logic may be distributed among the vendor applications themselves, enabling peer-to-peer coordination through new arbitration programming at the application tier. In other embodiments, arbitration logic may be centralized in an orchestration application, enabling resource-aware decisions that are unavailable to applications operating at the application tier. In each embodiment, the arbitration protocol may be augmented by a machine learning model trained on engagement history and device state data, enabling the system to refine outcomes over time without requiring manual updates to arbitration policies. The system may further provide a content-aware widget arbitration mechanism in which contextually relevant vendor applications are selectively identified using rules and/or a machine learning model, enabling efficient and intelligent widget presentation in the widget zone of the home screen.

This technical solution directly addresses the aforementioned technical problems and includes multiple embodiments for lock screen surface control. In a first embodiment directed to inter-application arbitration, vendor applications communicate render requests directly with one another through a peer-to-peer arbitration protocol, in which each participating vendor application is programmed with new arbitration logic enabling it to cooperatively resolve surface ownership conflicts without a central authority. In a second embodiment directed to centralized orchestration arbitration, the arbitration logic is removed from the individual vendor applications and placed entirely in an orchestration application executing at the mobile device (and/or at a remote server), in which the orchestration application has access to various types of data (e.g., state parameters, engagement history, server-delivered arbitration policies, etc.) that are unavailable to the individual vendor applications. The centralized architecture enables arbitration decisions of greater accuracy and resource-awareness than are achievable through peer-to-peer coordination alone. Both embodiments may include a common content-aware widget arbitration mechanism that governs widget presentation in the widget zone of the home screen upon occurrence of an unlock event, as further described below.

In the inter-application arbitration embodiment, each vendor application executing on the mobile device may be pre-programmed with arbitration logic enabling each vendor application to communicate directly with other registered vendor applications when seeking to present content on the lock screen surface. When a vendor application seeks to present content on the lock screen surface, the vendor application may broadcast a request message to all registered vendor applications. The request message may include, for example, a vendor application identifier and a requested display priority. Each receiving vendor application may evaluate the request message against arbitration policies (e.g., received from a remote server), and may transmit a response message indicating acceptance or rejection of the request from the vendor application.

The arbitration policies evaluated by each vendor application may govern the basic terms under which a vendor application is permitted to occupy the lock screen surface. For example, arbitration policies may specify the content types a vendor application is permitted to present, the permitted time-of-day windows during which the vendor application may acquire the lock screen surface, the maximum display duration for a given session, the minimum interval required between consecutive sessions for a given vendor application, etc. Arbitration policies may further include vendor priority weights and one or more carrier-defined conditions that govern how competing requests are resolved when two or more vendor applications seek to acquire the lock screen surface simultaneously. In some embodiments, the vendor applications may employ a machine learning model trained on engagement history and prior arbitration outcomes to augment the local policy evaluation, enabling the arbitration logic to improve resolution accuracy as additional session data accumulates over time.

Upon resolution of the arbitration evaluation, the vendor application whose request message is accepted may acquire ownership of the lock screen surface (e.g., acquire permission to present content on the lock screen) and may then present content to the user. If the requesting vendor application does not receive a response from other registered vendor applications within a defined threshold time period, the requesting vendor application may proceed to acquire the lock screen surface without further coordination, preventing indefinite arbitration delays in the absence of active competing applications. Upon completion of the lock screen session, the acquiring vendor application may transmit a completion message to the other registered vendor applications, signaling that the lock screen surface is available for a subsequent arbitration cycle. The engagement history associated with each vendor application may be updated following each completed session, providing updated signal for subsequent arbitration evaluations and machine learning model training. In this manner, the inter-application arbitration embodiment may enable competing vendor applications to cooperatively manage lock screen space ownership through direct communication, thereby substantially reducing the uncoordinated resource consumption that arises when vendor applications independently compete without a governing protocol.

In the centralized orchestration arbitration embodiment, arbitration decision logic may be removed from the individual vendor applications and placed in an orchestration application executing at the mobile device. The orchestration application may receive arbitration policies and widget policies from a remote server and store the policies in a local data store alongside device state parameters, engagement history, lock screen session data, and a vendor registry. The device state parameters may refer to a collection of real-time operational measurements associated with the mobile device, such as current CPU utilization, available memory capacity, and network connection state. Engagement history may refer to a persistent record of prior lock screen sessions associated with each vendor application, including content types presented, session durations, and user interaction events. Lock screen session data may refer to data describing active or recently completed lock screen sessions, including the acquiring vendor application identifier, session start time, and token type. The vendor registry may refer to a record of all vendor applications registered with the orchestration application, including their identifiers and registration attributes.

Each vendor application may transmit a registration request to the orchestration application upon initialization, in which the registration request may include a vendor application identifier and a requested display priority. The orchestration application may register each vendor application in the vendor registry and maintain a persistent record of all participating applications and their associated attributes. The remote server may periodically transmit updated arbitration policies and widget policies, enabling carrier-defined arbitration rules to be propagated to the mobile device without requiring application-level updates to any individual vendor application.

The orchestration application may use the device state parameters to supplement the arbitration policy evaluation at the time of a render request. Device state parameters may include, for example, current CPU utilization and available memory capacity, as well as active network connection type and current network signal strength, among other operational measurements. In some embodiments, the remote server may transmit device state parameter thresholds as part of the arbitration policies, enabling carrier-defined resource conditions to govern the circumstances under which render requests may be granted or deferred based on real-time device conditions. By incorporating device state parameters into the arbitration evaluation, the orchestration application may prevent vendor applications from acquiring ownership of the lock screen surface under resource conditions that would result in degraded rendering performance or operating system-level process throttling.

When a vendor application seeks to present content on the lock screen surface, the vendor application may transmit a render request to the orchestration application, in which the render request specifies a requested token type. The orchestration application may evaluate the render request against the arbitration policies, current device state parameters, and engagement history, to determine whether to grant or temporarily deny the render request. In some embodiments, the orchestration application may employ a machine learning model trained on engagement history and device state parameters to augment the arbitration decision (e.g., the model may be trained to identify engagement patterns and resource utilization trends).

If the render request is granted, the orchestration application may transmit a grant message to the requesting vendor application (e.g., with the requested token type). Upon completion of the lock screen session, the vendor application may transmit a release message to the orchestration application, and the orchestration application may update the engagement history in the data store to reflect the completed session, providing additional training signal for subsequent machine learning model evaluations.

Upon occurrence of an unlock event at the mobile device, the orchestration application may evaluate a broadcast policy to identify the vendor applications most relevant to the unlock context before transmitting a broadcast message. The broadcast policy evaluation may employ rules and/or a machine learning model trained on engagement histories. The orchestration application may evaluate the broadcast policies and/or use machine learning models to identify vendor applications having a content type that is most contextually aligned with the unlock event. By performing this filtering evaluation before broadcasting the broadcast message, the orchestration application may eliminate unnecessary computations at vendor applications with content that is irrelevant to the current context, reducing background processing overhead across the mobile device. The orchestration application may then transmit the broadcast message only to those vendor applications identified as contextually relevant, in which the broadcast message may include metadata describing a content type presented during the lock screen session or during the unlock event.

Each vendor application receiving the broadcast message may retrieve widget policies and engagement history from the data store and compute a widget engagement score based on the metadata comprised in the broadcast message and the widget policies retrieved from the data store. The widget engagement score may reflect the degree of alignment between the content type associated with the unlock event and the content type associated with the vendor application's widget. For example, the widget engagement score may be weighted by engagement history and evaluated against a minimum widget engagement score threshold defined in the widget policies. If the widget engagement score satisfies the minimum threshold, the vendor application may transmit a widget zone query to the launcher application to determine the current occupancy state of the widget zone on the home screen of the mobile device. The launcher application may return a widget zone status indicating whether the widget zone is available or currently occupied, and if occupied, identifying the current occupying widget and its associated vendor application. If the widget zone is available, the vendor application may transmit a present widget signal to the launcher application, causing the launcher application to present the widget associated with the vendor application in the widget zone of the home screen. If the widget zone is occupied by a widget with a content type that is not relevant to the unlock context, the vendor application may transmit a present widget signal, displacing the contextually irrelevant widget in favor of the more contextually relevant widget. On the other hand, if the incumbent widget is contextually relevant, the vendor application may refrain from transmitting a present widget signal, preserving the current widget and avoiding unnecessary displacement processing at the launcher application.

The technical challenges associated with competing vendor application access (e.g., uncoordinated network retrieval, redundant content preparation, stage collisions, and processing resource contention) may arise in connection with any shared engagement surface in which multiple vendor applications independently monitor for an activation trigger and initiate preparation operations without a governing coordination mechanism. Similarly, the arbitration and coordination mechanisms described herein — including peer-to-peer arbitration protocols, centralized orchestration arbitration, token-based permission models, and content-aware broadcast filtering — may be applicable to shared engagement surfaces beyond the lock screen surface to the extent that such surfaces present analogous access contention and resource consumption characteristics. Accordingly, while the detailed embodiments described below are directed to the lock screen surface as a representative shared engagement surface, it should be appreciated that the systems and methods disclosed herein may be applied to other shared engagement surfaces exhibiting similar coordination challenges.

This technical solution may directly address the aforementioned technical problems by eliminating the resource contention and redundant processing overhead arising from uncoordinated vendor application competition for the lock screen surface. By routing all arbitration through a governed coordination protocol — whether peer-to-peer or centralized — the system may prevent stage collisions and redundant network retrievals, reducing unnecessary processing utilization and network bandwidth consumption at the mobile device. In embodiments employing a machine learning model to augment arbitration decisions, the system may further refine outcomes over time as the model accumulates engagement history and device state data. By transmitting the broadcast message only to contextually relevant vendor applications and enabling intelligent widget displacement based on context relevance, the system may significantly reduce unnecessary widget engagement score computation, reduce background processing overhead, and ensure that the widget zone of the home screen reflects content that is most relevant to the user's current session context.

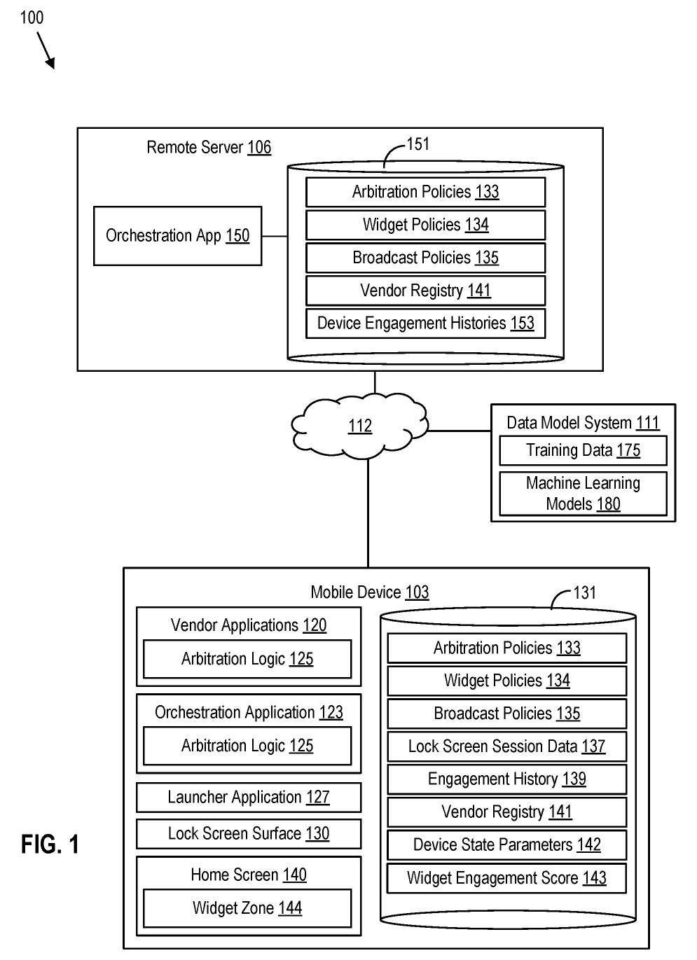

Turning now to FIG. 1, shown is a system 100 for managing competing vendor application access to the lock screen surface and widget zone of a mobile device. As shown in FIG. 1, system 100 includes a mobile device 103, a remote server 106, a data model system 111, and a network 112 communicatively coupling the mobile device 103, the remote server 106, and the data model system 111. While the remote server 106 and the data model system 111 are shown as separate components in FIG. 1, it should be appreciated that in some embodiments the remote server 106 may include the data model system 111, or the data model system 111 may be implemented as a distributed computational resource accessible by the remote server 106 via the network 112. The network 112 may be a public or private communication network enabling the mobile device 103 and the remote server 106 to securely exchange data.

The remote server 106 may refer to a server-side computing system operated by a carrier network or platform operator responsible for managing and distributing policies governing vendor application behavior at the mobile device 103. As shown in FIG. 1, the remote server 106 may include an orchestration application 150 and a data store 151. The data store 151 of the remote server 106 may store arbitration policies 133, widget policies 134, broadcast policies 135, vendor registry 141, and device engagement histories 153 associated with vendor applications across the carrier network. The orchestration application 150 may be configured to manage the lifecycle of these policies and to transmit updated policies to the orchestration application 123 at the mobile device 103 via the network 112. In this manner, the remote server 106 may serve as the authoritative policy source for the system 100, enabling carrier-defined rules to be propagated to the mobile device 103 without requiring application-level updates to any individual vendor application.

Arbitration policies 133 may refer to carrier-defined rules governing the basic terms under which a vendor application 120 is permitted to occupy the lock screen surface 130. An arbitration policy 133 may indicate, for example, permitted content types, permitted time-of-day windows, maximum display duration per session, and/or minimum intervals between consecutive sessions for a given vendor application. Widget policies 134 may refer to rules governing the conditions under which a vendor application 120 may present a widget in the widget zone 144 of the home screen 140. A widget policy 134 may include, for example, minimum widget engagement score thresholds, content type affinity rules, and/or carrier-defined display conditions. Broadcast policies 135 may refer to rules governing which vendor applications 120 are eligible to receive a broadcast message upon occurrence of an unlock event. A broadcast policy may include, for example, content type relevance criteria and/or carrier-defined targeting conditions. Device engagement histories 153 may refer to aggregated records of prior lock screen and widget interactions associated with vendor applications 120 across the carrier network, including content types presented, session durations, and user interaction events such as taps, dismissals, and dwell time. The vendor registry 141 may refer to a persistent record of all vendor applications 120 registered with the remote server 106 (e.g., identifiers, requested display priorities, and/or supported content type identifiers).

The data model system 111 may refer to a computational system configured to train and execute one or more machine learning models 180 using training data 175. The training data 175 may include device engagement histories 153 aggregated across numerous vendor applications and users of the carrier network, in which device engagement histories 153 may capture prior content interactions at the lock screen surface 130 and widget zone 144. For example, the training data may indicate the content types a user engaged with, session durations, tap and dismissal events, and/or time-of-day pattern. In this way, the training data may enable the machine learning models 180 to develop a predictive understanding of which lock screen content and widget content a given user is most likely to engage with under a given unlock context. The machine learning models 180 may be trained to generate predictions that supplement policy-based arbitration and broadcast decisions at the orchestration application 123. The data model system 111 may transmit trained machine learning models 180 or model outputs to the remote server 106 or directly to the orchestration application 123 via the network 112.

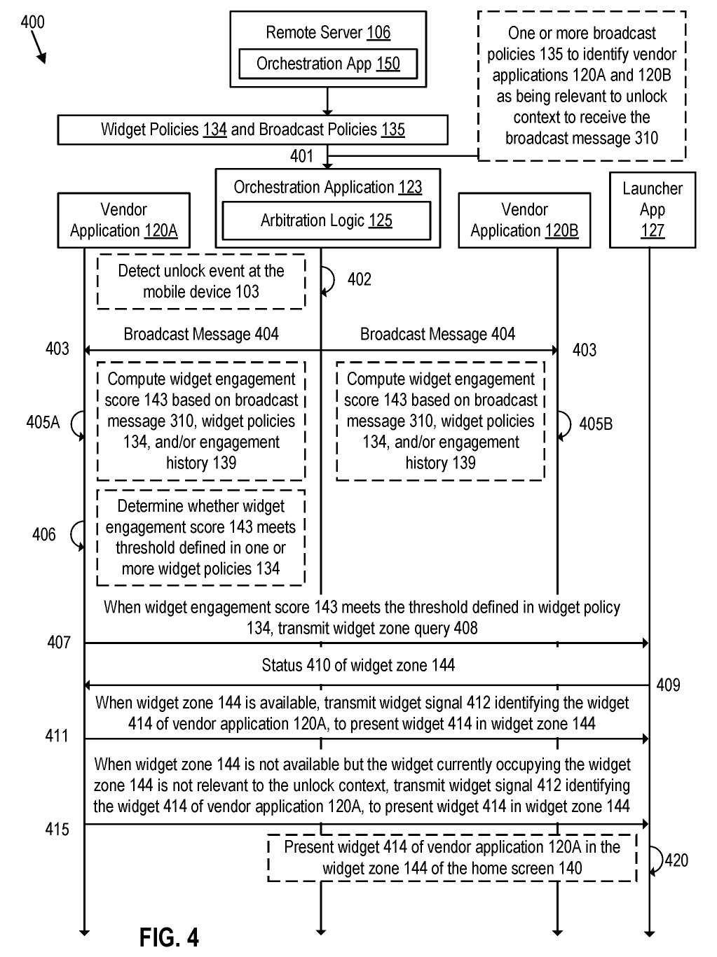

The mobile device 103 may refer to a mobile computing device, such as a smartphone or tablet, on which one or more vendor applications 120 seek to present content on the lock screen surface 130 or the widget zone 144 of the home screen 140. As shown in FIG. 1, the mobile device 103 may include an orchestration application 123, a launcher application 127, one or more vendor applications 120, a lock screen surface 130, a home screen 140, and a data store 131. The data store 131 may store arbitration policies 133, widget policies 134, broadcast policies 135, lock screen session data 137, engagement history 139, a vendor registry 141, device state parameters 142, and widget engagement scores 143. The home screen 140 may include a widget zone 144 in which a widget associated with a vendor application 120 may be presented upon satisfaction of the widget arbitration criteria described with respect to FIG. 4.

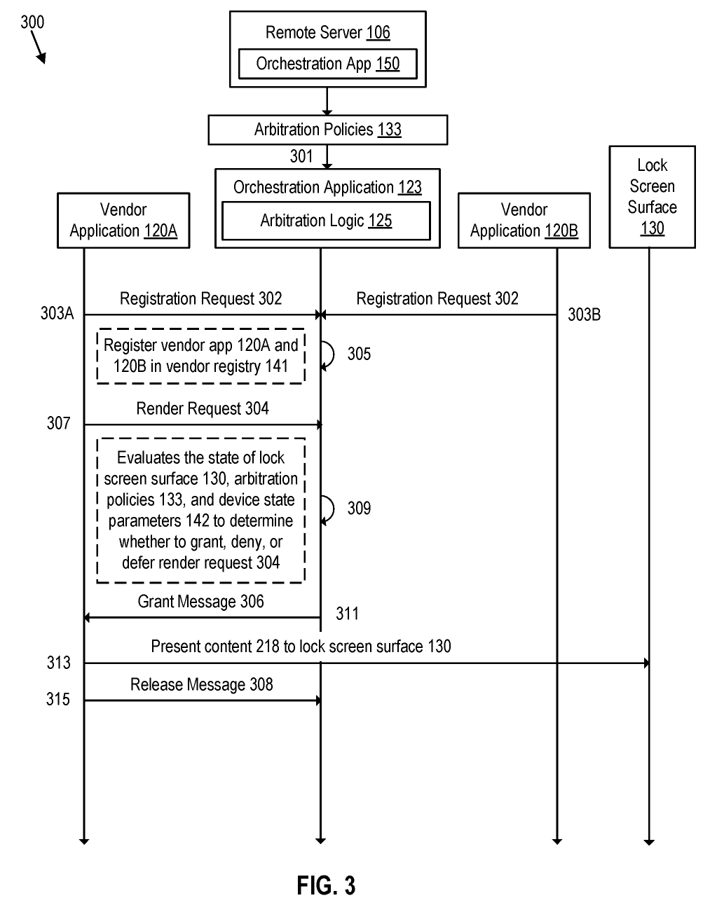

The orchestration application 123 may refer to a software application executing at the mobile device 103 that serves as a central arbitration authority for all participating vendor applications 120. The orchestration application 123 may include arbitration logic 125. The orchestration application 123 may be configured to receive arbitration policies 133, widget policies 134, and broadcast policies 135 from the remote server 106 and store them in the data store 131 for use in subsequent arbitration evaluations. The orchestration application 123 may further be configured to evaluate render requests received from vendor applications 120 against the arbitration policies 133, device state parameters 142, and engagement history 139, to determine whether to grant, deny, or defer each request, as further described with respect to FIG. 3. In some embodiments, the orchestration application 123 may employ machine learning models 180 at the data model system 111 to augment policy-based arbitration decisions, enabling the system to refine outcomes over time as engagement data accumulates.

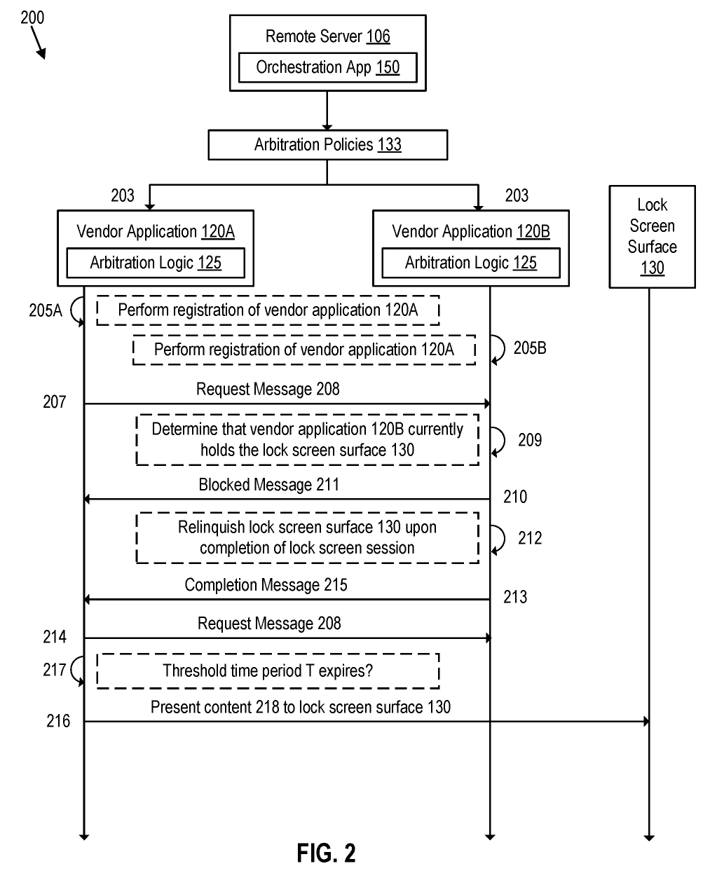

The vendor applications 120 may refer to third-party or carrier-affiliated software applications executing on the mobile device 103 that participate in the inter-application arbitration scheme by first registering with the orchestration application 123 and submitting render requests when seeking to present content on the lock screen surface 130. As shown in FIG. 1, each vendor application 120 may include arbitration logic 125, in which the arbitration logic 125 enables direct peer-to-peer coordination between vendor applications 120 in the inter-application arbitration embodiment described with respect to FIG. 2. In the centralized orchestration embodiment, the arbitration logic 125 within each vendor application 120 is contained in the orchestration application 123, which assumes centralized control of all arbitration decisions. Each vendor application 120 may also be configured to compute a widget engagement score 143 and interact with the launcher application 127 to present an associated widget in widget zone 144, as further described with respect to FIG. 4.

The launcher application 127 may refer to a system-level application executing at the mobile device 103 that manages the layout and content of the home screen 140. The launcher application 127 may be configured to receive present widget signals from vendor applications 120, manage the occupancy state of widget zone 144, and present or displace widgets in widget zone 144 in response to those signals. The launcher application 127 may further be configured to return a widget zone status to a querying vendor application 120 indicating whether widget zone 144 is currently available or occupied, and if occupied, identifying the current occupying widget and its associated vendor application, as further described with respect to FIG. 4.

The data store 131 may refer to a local storage component of the mobile device 103 configured to persistently store policy and session data used by the orchestration application 123 and the vendor applications 120. Lock screen session data 137 may refer to data describing active or recently completed lock screen sessions, including the acquiring vendor application identifier, session start time, and/or token type granted. Engagement history 139 may refer to a persistent record of prior lock screen sessions associated with each vendor application 120, including, for example, content types presented, session durations, and/or user interaction events, and may serve as training signal for the machine learning models 180. As mentioned above, the vendor registry 141 may refer to a persistent record of all vendor applications 120 registered with the orchestration application 123 (e.g., identifiers, requested display priorities, and/or supported content type identifiers). Device state parameters 142 may refer to real-time operational measurements of the mobile device 103 (e.g., processor utilization, available memory, network connection type, and signal strength) that the orchestration application 123 may evaluate at the time of a render request to prevent content display under resource conditions that would, for example, result in degraded rendering performance. Widget engagement score 143 may refer to a computed value reflecting the degree of alignment between the content type associated with a vendor application's widget and the context of the most recent unlock event, as further described with respect to FIG. 4.

Referring now to FIG. 2, shown is a message sequence diagram illustrating a method 200 for peer-to-peer lock screen surface arbitration between vendor applications according to various embodiments of the disclosure. In particular, method 200 may illustrate communications between the remote server 106, vendor application 120A and vendor application 120B each executing at the mobile device 103, and the lock screen surface 130. In the example shown in method 200, each vendor application 120 may be pre-programmed with arbitration logic 125 enabling direct peer-to-peer coordination without routing decisions through the orchestration application 123.

Method 200 may begin with operation 203, in which the remote server 106 transmits arbitration policies 133 to vendor application 120A and vendor application 120B. The arbitration policies 133 received at this step may govern the basic terms under which each vendor application 120 is permitted to seek and occupy the lock screen surface 130. Each vendor application 120 may store the received arbitration policies 133 locally for evaluation during subsequent arbitration cycles.

At operation 205A and operation 205B, vendor application 120A and vendor application 120B each perform registration with the arbitration system. Registration may refer to the process by which each vendor application 120 initializes its arbitration logic 125 and establishes its identity and attributes within the peer-to-peer arbitration scheme. During registration, each vendor application 120 may transmit a registration request to the other participating vendor applications 120, in which the registration request may comprise a vendor application identifier, a requested display priority, and/or one or more supported content type identifiers. Each receiving vendor application 120 may store the registration attributes of the registering vendor application 120 in a local vendor registry 141, enabling each vendor application 120 to maintain an awareness of all eligible arbitration participants.

Upon completion of registration, each vendor application 120 may be recognized by the other participating vendor applications 120 as an eligible participant in the arbitration cycle. In some embodiments, registration may further include retrieving and locally caching the most recently received arbitration policies 133 from the remote server 106 to ensure that the arbitration logic 125 at each vendor application 120 is operating against a current policy set at the time of any subsequent arbitration evaluation.

At operation 207, vendor application 120A seeks to present content on lock screen surface 130 and initiates a peer-to-peer arbitration evaluation by transmitting a request message 208 to vendor application 120B. For example, the request message 208 may include a vendor application identifier associated with vendor application 120A and a requested display priority. In an embodiment, the request message 208 may also include supported content type identifiers and/or a timestamp reflecting the time at which the request was initiated.

At operation 209, vendor application 120B evaluates the request message 208 against the arbitration policies 133 and its own current occupancy state of the lock screen surface 130 to determine that vendor application 120B currently holds the lock screen surface 130. Upon making this determination, vendor application 120B may transmit a blocked message 211 to vendor application 120A at operation 210, in which the blocked message 211 indicates that the lock screen surface 130 is currently occupied and the request from vendor application 120A cannot be honored at this time. For example, the blocked message 211 may include a vendor application identifier associated with vendor application 120B and/or an estimated session duration, enabling vendor application 120A to determine an appropriate deferral interval before re-initiating the arbitration evaluation. The blocked message 211 may enable vendor application 120A to defer its content preparation operations until the lock screen surface 130 becomes available.

At operation 212, vendor application 120B relinquishes the lock screen surface 130 upon completion of its lock screen session. Upon relinquishing the lock screen surface 130, vendor application 120B may transmit a completion message 215 to vendor application 120A at operation 213, in which the completion message 215 signals that the lock screen surface 130 is now available for a subsequent arbitration cycle. For example, the completion message 215 may include a vendor application identifier associated with vendor application 120B, a session duration value reflecting the length of the completed lock screen session, and/or a content type identifier reflecting the content type presented during the session, enabling the receiving vendor application 120A to update engagement history 139 and inform subsequent arbitration evaluations. The engagement history 139 associated with vendor application 120B may be updated following this completed session, providing updated signal for subsequent arbitration evaluations and machine learning model training at the data model system 111.

At operation 214, vendor application 120A, upon receipt of the completion message 215, may re-initiate the arbitration evaluation by transmitting a second request message 208 to vendor application 120B. In this way, vendor application 120A may re-submit a request message 208 to confirm that no other registered vendor application 120 has acquired the lock screen surface 130 in the interval since the completion message 215 was received.

At operation 217, vendor application 120A determines a threshold time period T has expired since transmitting the second request message 208. The threshold time period T may refer to a configurable timeout value defined in the arbitration policies 133, such that if vendor application 120A does not receive a response to its request message 208 from other registered vendor applications 120 within the threshold time period T, vendor application 120A may proceed to acquire the lock screen surface 130 without further coordination. This mechanism may prevent indefinite arbitration delays in conditions where other registered vendor applications 120 are inactive. If vendor application 120A receives a blocked message 211 from vendor application 120B before the threshold time period T expires, the arbitration evaluation may continue, in which vendor application 120A may defer its content preparation operations and await a subsequent completion message 215 before re-initiating the arbitration evaluation, as described above with respect to operations 209 and 210.

At operation 216, vendor application 120A presents content 218 on lock screen surface 130 upon successfully acquiring surface ownership through the peer-to-peer arbitration protocol (e.g., either by receiving an acceptance response from vendor application 120B or by expiration of the threshold time period T without a blocking response). The content 218 presented at this step may reflect the content type associated with vendor application 120A and permitted by the arbitration policies 133 received from the remote server 106.

In some embodiments, the machine learning models 180 at the data model system 111 may be trained on engagement history 139 accumulated across prior arbitration sessions, enabling the arbitration logic 125 within each vendor application 120 to improve surface ownership resolution accuracy over time as additional session data accumulates.

Referring now to FIG. 3, shown is a message sequence diagram illustrating a method 300 for centralized orchestration arbitration according to various embodiments of the disclosure. In particular, method 300 may illustrate communications between the remote server 106, the orchestration application 123, vendor application 120A, vendor application 120B, and the lock screen surface 130, each executing at or associated with the mobile device 103. In contrast to method 200 of FIG. 2, in which arbitration logic 125 is distributed among the vendor applications 120 themselves, the arbitration logic 125 in method 300 may be provisioned at the orchestration application 123, which may evaluate render requests against arbitration policies 133, device state parameters 142, and/or engagement history 139 stored in the data store 131.

In method 300, the operational rights of vendor applications 120A and 120B may be governed by the orchestration application 123 through a token-based permission model. A refresh token may refer to permission granted to a vendor application 120 to retrieve or update content from a remote endpoint. A staging token may refer to permission granted to a vendor application 120 to prepare that content into a render-ready form (e.g., operations such as image decoding, layout preparation, and payload caching). A render token may refer to exclusive permission granted to a vendor application 120 to publish visible content to the lock screen surface 130 during a specific interaction window. A priority override token may refer to an elevated permission granted to a vendor application 120 to acquire the lock screen surface 130 ahead of its normal arbitration priority, in which the orchestration application 123 may issue a priority override token when a carrier-defined campaign condition, a time-sensitive content event, or a machine learning model prediction satisfies a threshold defined in the arbitration policies 133 sufficient to justify displacing the normal priority order. By separating these four rights, the orchestration application 123 may allow multiple vendor applications 120 to hold refresh tokens and staging tokens concurrently (e.g., remaining prepared with fresh content) while ensuring that only one vendor application 120 holds a render token or priority override token at any given time. Tokens may be time-bounded and revocable, enabling the orchestration application 123 to recover quickly if a vendor application 120 crashes or fails to release a token within its validity window.

Each of the aforementioned tokens may refer to a short-lived alphanumeric value generated by the orchestration application 123 at the mobile device 103 and/or the orchestration application 150 at the remote server 106 upon a determination that a render request 304 satisfies the arbitration policies 133 and current device state parameters 142. The orchestration application 123 or 150 may generate each token by associating a unique session identifier, a token type designation, and/or a token validity window that defines the maximum duration for which the token remains active. Upon generation, the orchestration application 123 or 150 may store the token and its associated attributes in the lock screen session data 137 of the data store 131 or 151, enabling the orchestration application 123 to verify token validity at any point during the lock screen session. The orchestration application 123 or 150 may transmit the token to the requesting vendor application 120 as part of the grant message 306, and the vendor application 120 may present the token when invoking system-level APIs to publish content to the lock screen surface 130, enabling the orchestration application 123 to confirm that the publishing vendor application 120 holds a currently valid token before permitting the content to be rendered. A token may be invalidated upon the earlier of the token validity window elapsing, the vendor application 120 transmitting a release message 308 to the orchestration application 123, or the orchestration application 123 issuing a revocation signal in response to a change in device state parameters 142 or arbitration policy conditions that would have resulted in denial of the original render request.

Method 300 may begin with operation 301, in which the remote server 106 transmits arbitration policies 133 to the orchestration application 123. By delivering arbitration policies 133 directly to the orchestration application 123 rather than to each individual vendor application 120, the remote server 106 may enable centralized policy governance. The orchestration application 123 may store the received arbitration policies 133 in the data store 131 for use in subsequent arbitration evaluations.

At operation 303A and 303B, vendor application 120A and vendor application 120B each transmit a registration request 302 to the orchestration application 123. The registration request 302 may include a vendor application identifier, a requested display priority, and/or one or more supported content type identifiers associated with the registering vendor application 120. At operation 305, after receiving the registration requests 302, the orchestration application 123 may register vendor application 120A and vendor application 120B in the vendor registry 141 stored in the data store 131 (e.g., by storing the data received in the registration requests 302 pertaining to each vendor application 120A and 120B in the vendor registry 141). The vendor registry 141 may thus reflect a current and complete record of all vendor applications 120 that have registered with the orchestration application 123 and are eligible to participate in subsequent arbitration cycles.

At operation 307, vendor application 120A seeks to present content on the lock screen surface 130 and transmits a render request 304 to the orchestration application 123. The render request 304 may specify a requested token type — in this case, a render token — as well as other data (e.g., a vendor application identifier, a content type identifier associated with the content vendor application 120A seeks to present, etc.). At operation 309, the orchestration application 123 evaluates the render request 304 against the arbitration policies 133, the current state of the lock screen surface 130, and/or device state parameters 142 to determine whether to grant, deny, or defer the request. In some embodiments, the orchestration application 123 may also evaluate engagement history 139 and may employ a machine learning model 180 from the data model system 111 to augment the policy-based evaluation, enabling the model to incorporate engagement patterns and resource utilization trends that may not be fully captured by rule-based arbitration policies 133 alone.

At operation 311, the orchestration application 123 transmits a grant message 306 to vendor application 120A. The grant message 306 may include the render token authorizing vendor application 120A to occupy the lock screen surface 130, a token validity window defining the maximum duration for which the render token remains active, and/or a session identifier associating the token with the current arbitration transaction. The render token may authorize vendor application 120A to publish to the lock screen surface 130 the content that vendor application 120A has already prepared during a prior staging phase. At operation 313, vendor application 120A may present content 218 on the lock screen surface 130 pursuant to the render token granted in the grant message 306, and only for the duration defined by the token validity window.

At operation 315, upon completion of the lock screen session, vendor application 120A transmits a release message 308 to the orchestration application 123, signaling that vendor application 120A has relinquished ownership of the lock screen surface 130. The release message 308 may include the session identifier received in the grant message 306, a session duration value reflecting the length of the completed lock screen session, and a content type identifier reflecting the content type presented during the session. Upon receipt of the release message 308, the orchestration application 123 may update the engagement history 139 in the data store 131 to reflect the completed session — including the content type presented, the session duration, and any user interaction events captured during the session. This updated engagement history 139 may serve as additional training data 175 for the machine learning models 180 at the data model system 111, enabling the system to refine subsequent arbitration evaluations over time.

Referring now to FIG. 4, shown is a message sequence diagram illustrating a method 400 for content-aware widget arbitration according to various embodiments of the disclosure. In particular, method 400 may illustrate communications between the remote server 106, the orchestration application 123, vendor application 120A, vendor application 120B, and the launcher application 127, each executing at or associated with the mobile device 103. Method 400 may govern whether and how a vendor application 120 may present a widget in the widget zone 144 of the home screen 140.

Method 400 may begin with operation 401, in which the remote server 106 transmits widget policies 134 and broadcast policies 135 to the orchestration application 123. The widget policies 134 may include conditions governing the circumstances under which a vendor application 120 may present a widget in the widget zone 144. The orchestration application 123 may store the received widget policies 134 and broadcast policies 135 in the data store 131 for use during subsequent unlock event evaluations.

At operation 402, the orchestration application 123 detects an unlock event at the mobile device 103, transitioning the mobile device 103 from a locked state to an unlocked state and exposing the home screen 140 and widget zone 144 of the home screen 140. After detecting the unlock event, the orchestration application 123 may evaluate the broadcast policies 135 to determine which vendor applications 120 are most contextually relevant to the unlock context. In some embodiments, this evaluation may employ a machine learning model 180 from the data model system 111 trained on device engagement histories 153, enabling the orchestration application 123 to identify vendor applications 120 that have a content type that are most likely to generate user engagement given the current unlock context. For example, if the content most recently presented on the lock screen surface 130 during the preceding lock screen session was associated with a sporting event (e.g., a live score update or game highlight), vendor applications 120 associated with sports, sports media, or sports wagering may be identified as contextually relevant to the unlock event (e.g., based on patterns in prior user engagement with similar content types recorded in the device engagement histories 153).

At operation 403, the orchestration application 123 transmits a broadcast message 404 to vendor application 120A and vendor application 120B. The broadcast message 404 may include metadata describing the content type associated with the unlock context (e.g., a content type identifier reflecting the content most recently presented on the lock screen surface 130). The broadcast message 404 may further include, for example, a session identifier associated with the preceding lock screen session, a timestamp reflecting the time of the unlock event, and/or one or more contextual signals derived from device engagement histories 153 that informed the broadcast policy evaluation. By transmitting the broadcast message 404 only to those vendor applications 120 identified as contextually relevant under the broadcast policies 135, the orchestration application 123 may eliminate unnecessary computations at irrelevant vendor applications 120, reducing background processing overhead at the mobile device 103.

At operations 405A and 405B, each of vendor application 120A and vendor application 120B computes a widget engagement score 143 based on the metadata in the broadcast message 404, the widget policies 134, and/or engagement history 139 retrieved from the data store 131. The widget engagement score 143 may reflect the degree of alignment between the content type of the unlock event and the content type of the vendor application's widget, weighted by prior engagement events recorded in the engagement history 139. At operation 406, each vendor application 120 evaluates whether the computed widget engagement score 143 meets the minimum threshold defined in one or more of the widget policies 134. If the widget engagement score 143 does not meet the threshold, the vendor application 120 may refrain from transmitting a widget zone query 408.

At operation 407, when the vendor application 120A has widget engagement score 143 that meets the minimum threshold, may transmit a widget zone query 408 to the launcher application 127 to determine the current occupancy state of the widget zone 144. At operation 409, the launcher application 127 may return a status 410 of the widget zone 144 to vendor application 120A indicating whether the widget zone 144 is currently available or occupied. The status 410 may also indicate the current occupying widget and its associated vendor application identifier if the widget zone 144 is occupied.

At operation 411, if the status 410 indicates that the widget zone 144 is available, vendor application 120A may transmit a widget signal 412 to the launcher application 127, identifying widget 414 associated with vendor application 120A. After receipt of the widget signal 412, the launcher application 127 may execute operation 420, presenting widget 414 in the widget zone 144 of the home screen 140.

At operation 415, if the status 410 indicates that the widget zone 144 is occupied by a widget with a content type that is not relevant to the unlock context (e.g., as determined by evaluating the content type of the incumbent widget against the metadata in the broadcast message 404) vendor application 120A may transmit a present widget signal 412 to the launcher application 127, identifying widget 414 as the replacement widget. The launcher application 127 may then execute operation 420, displacing the contextually irrelevant widget and presenting widget 414 in the widget zone 144. If the current widget is determined to be contextually relevant, vendor application 120A may refrain from transmitting a present widget signal 412, preserving the current widget and avoiding unnecessary displacement processing at the launcher application 127.

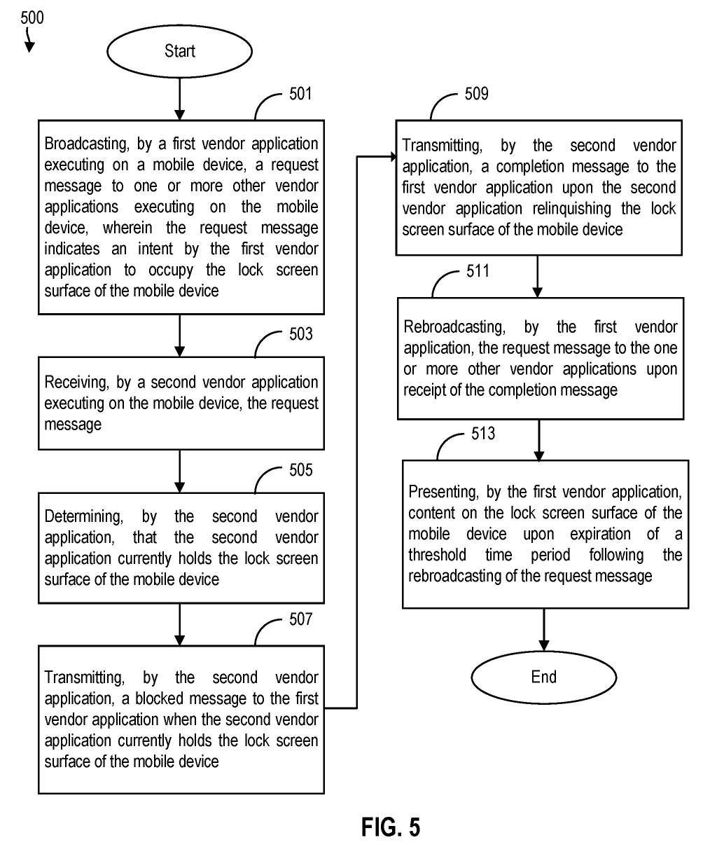

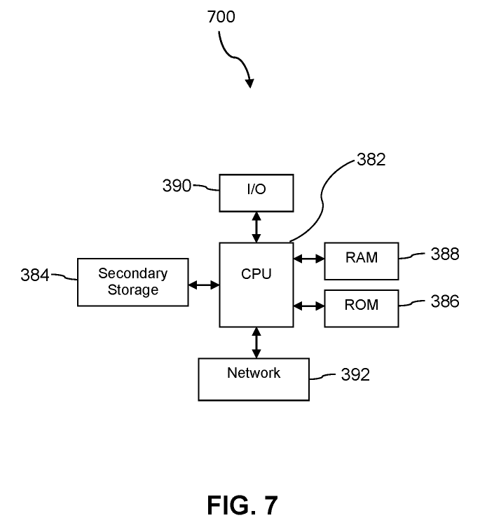

Turning now to FIG. 5, shown is a method 500 for managing competing access to a lock screen surface of a mobile device according to an embodiment of the present disclosure. Method 500 may be performed by vendor applications 120 executing at the mobile device 103. In embodiments, method 500 may be implemented using a computer system with components as shown in FIG. 7. As illustrated, method 500 of FIG. 5 includes a number of enumerated operations, but embodiments of method 500 may include additional operations before, after, and in between the enumerated operations. In some embodiments, one or more of the enumerated operations may be omitted or performed in a different order.

At step 501, method 500 comprises broadcasting, by a first vendor application 120A executing on the mobile device 103, a request message 208 to one or more other vendor applications 120 executing on the mobile device 103. In an embodiment, the request message 208 indicates an intent by vendor application 120A to occupy the lock screen surface 130. The request message 208 may be broadcast to all registered vendor applications 120 as identified in the vendor registry 141 stored in the data store 131.

At step 503, method 500 comprises receiving, by a second vendor application 120B executing on the mobile device 103, the request message 208. After receipt of the request message 208, vendor application 120B may evaluate the request message 208 against the arbitration policies 133 and its own current occupancy state of the lock screen surface 130.

At step 505, method 500 comprises determining, by vendor application 120B, that vendor application 120B currently holds the lock screen surface 130. This determination may reflect that vendor application 120B holds an active lock screen session at the time the request message 208 is received, and that the arbitration policies 133 may not require vendor application 120B to yield the lock screen surface 130 to the requesting vendor application 120A at this time.

At step 507, method 500 comprises transmitting, by vendor application 120B, a blocked message 211 to vendor application 120A. In an embodiment, the blocked message 211 indicates that the lock screen surface 130 is currently occupied. The blocked message 211 may include a status indicator identifying vendor application 120B as the current holder of the lock screen surface 130, as well as an estimated session duration enabling vendor application 120A to determine an appropriate deferral interval before re-initiating the arbitration evaluation.

At step 509, method 500 comprises transmitting, by vendor application 120B, a completion message 215 to vendor application 120A upon vendor application 120B relinquishing the lock screen surface 130. The completion message 215 may signal that the lock screen surface 130 is now available for a subsequent arbitration cycle.

At step 511, method 500 comprises rebroadcasting, by vendor application 120A, the request message 208 to the one or more other vendor applications 120 upon receipt of the completion message 215. This rebroadcast may confirm that no other registered vendor application 120 has acquired the lock screen surface 130 in the interval since the completion message 215 was received.

At step 513, method 500 comprises presenting, by vendor application 120A, content 218 on the lock screen surface 130 upon expiration of a threshold time period T following the rebroadcasting of the request message 208. The threshold time period T may refer to a configurable timeout value defined in the arbitration policies 133, such that if no blocking response is received within the threshold time period T, vendor application 120A may proceed to acquire the lock screen surface 130 without further coordination.

Method 500 may include other steps and features not otherwise shown in FIG. 5. In an embodiment, the request message 208 may comprise at least one of a vendor application identifier, a requested display priority, a content type identifier, or a timestamp, enabling receiving vendor applications 120 to evaluate the request against the arbitration policies 133 governing permitted content types and time-of-day display conditions. In an embodiment, the blocked message 211 may comprise a status indicator identifying vendor application 120B as the current holder of the lock screen surface 130 of the mobile device 103.

In an embodiment, the completion message 215 may comprise at least one of a vendor application identifier identifying vendor application 120B, a content type identifier describing content presented by vendor application 120B during its lock screen session, or a timestamp indicating when vendor application 120B relinquished the lock screen surface 130 of the mobile device 103. In an embodiment, method 500 may further comprise evaluating, by vendor application 120B, one or more arbitration policies 133 prior to transmitting the blocked message 211, in which the one or more arbitration policies 133 define conditions under which vendor application 120B may yield the lock screen surface 130 to vendor application 120A (e.g., when vendor application 120A holds a higher priority level than vendor application 120B, as defined by vendor priority weights stored in the arbitration policies 133).

In an embodiment, method 500 may further comprise evaluating, by a machine learning model 180 executing on a computing device in communication with the mobile device 103, a predicted engagement score associated with vendor application 120A prior to broadcasting the request message 208. In an embodiment, the request message 208 is broadcast only when the predicted engagement score satisfies a threshold value defined in the arbitration policies 133. The machine learning model 180 may be trained on engagement history 139 and device engagement histories 153 to identify content engagement patterns associated with vendor application 120A and the current unlock context.

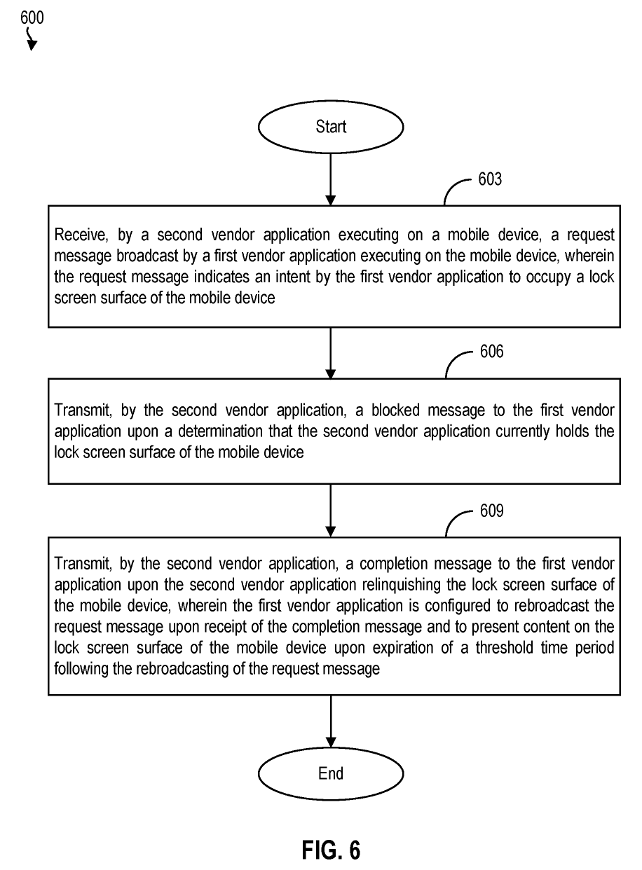

Turning now to FIG. 6, shown is a method 600 for managing competing access to a lock screen surface of a mobile device according to an embodiment of the present disclosure. Method 600 may be performed by vendor application 120B executing at the mobile device 103, and represents the perspective of a currently occupying vendor application receiving and responding to a competing request from vendor application 120A. In embodiments, method 600 may be implemented using a computer system with components as shown in FIG. 7. As illustrated, method 600 of FIG. 6 includes a number of enumerated operations, but embodiments of method 600 may include additional operations before, after, and in between the enumerated operations. In some embodiments, one or more of the enumerated operations may be omitted or performed in a different order.

At step 603, method 600 comprises receiving, by vendor application 120B executing on the mobile device 103, a request message 208 broadcast by vendor application 120A executing on the mobile device 103. In an embodiment, the request message 208 indicates an intent by vendor application 120A to occupy the lock screen surface 130 of the mobile device 103. After receipt of the request message 208, vendor application 120B may evaluate the request message 208 against the arbitration policies 133 and the current occupancy state of the lock screen surface 130 maintained in the data store 131.

At step 606, method 600 comprises transmitting, by vendor application 120B, a blocked message 211 to vendor application 120A upon a determination that vendor application 120B currently holds the lock screen surface 130 of the mobile device 103. The blocked message 211 may include a status indicator identifying vendor application 120B as the current holder of the lock screen surface 130, enabling vendor application 120A to defer content preparation operations until the lock screen surface 130 becomes available.

At step 609, method 600 comprises transmitting, by vendor application 120B, a completion message 215 to vendor application 120A upon vendor application 120B relinquishing the lock screen surface 130 of the mobile device 103. The completion message 215 may signal to vendor application 120A that the lock screen surface 130 is available for a subsequent arbitration cycle. After relinquishing the lock screen surface 130, vendor application 120B may also update the engagement history 139 in the data store 131 to reflect the completed session. Vendor application 120A may be configured to rebroadcast the request message 208 after receipt of the completion message 215 and to present content 218 on the lock screen surface 130.

Method 600 may include other steps and features not otherwise shown in FIG. 6. In an embodiment, method 600 may further comprise evaluating, by vendor application 120B, one or more arbitration policies 133 stored in a data store 131 accessible by vendor application 120B to determine whether to yield the lock screen surface 130 prior to transmitting the completion message 215. In an embodiment, the one or more arbitration policies 133 may define conditions under which vendor application 120B should relinquish the lock screen surface 130 to vendor application 120A.

In an embodiment, the one or more arbitration policies 133 may comprise one or more rules that evaluate at least one of a content freshness condition associated with content currently held by vendor application 120B, a priority level comparison between vendor application 120A and vendor application 120B, or a device resource condition of the mobile device 103, to determine whether vendor application 120B should yield the lock screen surface 130. In an embodiment, the completion message 215 transmitted at step 605 may comprise at least one of a vendor application identifier identifying vendor application 120B, a content type identifier describing content presented by vendor application 120B during the period in which vendor application 120B held the lock screen surface 130, or a timestamp indicating when vendor application 120B relinquished the lock screen surface 130.

In an embodiment, method 600 may further comprise evaluating, by a machine learning model 180 executing on the mobile device 103 or on a computing device in communication with the mobile device 103, a predicted engagement score associated with vendor application 120A, in which the request message 208 is acted upon only when the predicted engagement score satisfies a threshold value defined in the arbitration policies 133. The machine learning model 180 may be trained on engagement history 139 accumulated across prior arbitration sessions, enabling the model to identify engagement patterns associated with vendor application 120A that inform whether the competing request should be honored.

FIG. 7 illustrates a computer system 700 suitable for implementing one or more embodiments disclosed herein. In an embodiment, the mobile device 103, remote server 106, etc., may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for dynamically managing lock screen content and widget display on a mobile device, wherein the system comprises:
one or more memories;
one or more processors coupled to the one or more memories;
an orchestration application stored at the one or more memories, which when executed by the one or more processors, causes the orchestration application to be configured to:
receive a registration request from each of a plurality of vendor applications seeking access to a lock screen surface of a mobile device;
register each of the plurality of vendor applications in a vendor registry stored in a data store accessible by the orchestration application;
receive a render request from a requesting vendor application of the plurality of vendor applications;
evaluate a state of the lock screen surface of the mobile device and one or more arbitration policies to determine whether to render content from the requesting vendor application on the lock screen surface of the mobile device;
transmit a grant message, a deny message, or a defer message to the requesting vendor application based on the evaluation of the state of the lock screen surface and the one or more arbitration policies;
receive a release message from the requesting vendor application upon completion of a lock screen session at the mobile device; and
transmit a broadcast message to one or more vendor applications of the plurality of vendor applications upon occurrence of an unlock event at the mobile device, wherein the broadcast message comprises metadata describing a content type presented during the lock screen session or during the unlock event;
the plurality of vendor applications stored at the one or more memories, which when executed by the one or more processors, causes a vendor application of the plurality of vendor applications to be configured to:
receive the broadcast message from the orchestration application;
evaluate a widget engagement score based at least in part on the metadata included in the broadcast message and one or more widget policies; and
selectively present a widget associated with the vendor application on a home screen of the mobile device or suppress the widget based on the widget engagement score.

2. The system of claim 1, wherein the one or more arbitration policies comprise one or more rules that evaluate at least one of device resource conditions, network conditions, vendor priority weights, or engagement history stored in the data store to determine whether to grant, deny, or defer the render request from the requesting vendor application, wherein the device resource conditions comprise at least one of processor utilization, available memory, battery state, or available network bandwidth of the mobile device.

3. The system of claim 1, wherein the orchestration application is further configured to receive the one or more arbitration policies from a remote policy server, wherein the one or more arbitration policies define at least one of vendor priority weights, refresh cadence limits, or campaign override windows applicable to the plurality of vendor applications.

4. The system of claim 1, wherein the orchestration application is further configured to adapt the one or more arbitration policies over time using a machine learning model trained on engagement history stored in the data store.

5. The system of claim 1, wherein the broadcast message is transmitted by the orchestration application to a subset of the plurality of vendor applications determined by a broadcast policy stored in the data store.

6. The system of claim 1, wherein the render request specifies a requested token type comprising at least one of: a refresh token, a staging token, a render token, or a priority override token, and wherein the grant message comprises the requested token type upon a determination that the state of the lock screen surface and the one or more arbitration policies permit rendering by the requesting vendor application.

7. The system of claim 1, wherein the one or more widget policies comprise one or more rules that evaluate at least one of a content type affinity associated with the vendor application, a time-of-day condition, a minimum widget engagement score threshold, or a carrier-defined display condition to determine whether to present or suppress the widget
on the home screen of the mobile device.

8. A method for managing competing access to a lock screen surface of a mobile device, comprising:
broadcasting, by a first vendor application executing on a mobile device, a request message to one or more other vendor applications executing on the mobile device, wherein the request message indicates an intent by the first vendor application to occupy the lock screen surface of the mobile device;
receiving, by a second vendor application executing on the mobile device, the request message;
determining, by the second vendor application, that the second vendor application currently holds the lock screen surface of the mobile device;
transmitting, by the second vendor application, a blocked message to the first vendor application when the second vendor application currently holds the lock screen surface of the mobile device;
transmitting, by the second vendor application, a completion message to the first vendor application upon the second vendor application relinquishing the lock screen surface of the mobile device;
rebroadcasting, by the first vendor application, the request message to the one or more other vendor applications upon receipt of the completion message; and
presenting, by the first vendor application, content on the lock screen surface of the mobile device upon expiration of a threshold time period following the rebroadcasting of the request message.

9. The method of claim 8, wherein the request message comprises at least one of a vendor application identifier, a requested display priority, a content type identifier, or a timestamp.

10. The method of claim 8, wherein the blocked message comprises a status indicator identifying the second vendor application as a current holder of the lock screen surface of the mobile device.

11. The method of claim 8, wherein the completion message comprises at least one of a vendor application identifier identifying the second vendor application, a content type identifier describing content presented by the second vendor application during a period in which the second vendor application held the lock screen surface of the mobile device, or a timestamp indicating when the second vendor application relinquished the lock screen surface of the mobile device.

12. The method of claim 8, further comprising evaluating, by the second vendor application, one or more arbitration policies prior to transmitting the blocked message, wherein the one or more arbitration policies define conditions under which the second vendor application may yield the lock screen surface of the mobile device to the first vendor application.

13. The method of claim 12, wherein the one or more arbitration policies comprise a priority level comparison between the first vendor application and the second vendor application, wherein the second vendor application yields the lock screen surface of the mobile device when the first vendor application holds a higher priority level than the second vendor application.

14. The method of claim 8, further comprising evaluating, by a machine learning model executing at a data model system in communication with the mobile device, a predicted engagement score associated with the first vendor application prior to broadcasting the request message, wherein the request message is broadcast only when the predicted engagement score satisfies a threshold value.

15. A non-transitory computer-readable medium comprising instructions that, when executed by one or more processors, cause the one or more processors to:
receive, by a second vendor application executing on a mobile device, a request message broadcast by a first vendor application executing on the mobile device, wherein the request message indicates an intent by the first vendor application to occupy a lock screen surface of the mobile device;
transmit, by the second vendor application, a blocked message to the first vendor application upon a determination that the second vendor application currently holds the lock screen surface of the mobile device; and
transmit, by the second vendor application, a completion message to the first vendor application upon the second vendor application relinquishing the lock screen surface of the mobile device, wherein the first vendor application is configured to rebroadcast the request message upon receipt of the completion message and to present content on the lock screen surface of the mobile device upon expiration of a threshold time period following the rebroadcasting of the request message.

16. The non-transitory computer-readable medium of claim 15, wherein the instructions further cause the one or more processors to evaluate one or more arbitration policies stored in a data store accessible by the second vendor application to determine whether to yield the lock screen surface of the mobile device prior to transmitting the completion message.

17. The non-transitory computer-readable medium of claim 16, wherein the one or more arbitration policies comprise one or more rules that evaluate at least one of a content freshness condition associated with content currently held by the second vendor application, a priority level comparison between the first vendor application and the second vendor application, or a device resource condition of the mobile device, to determine whether the second vendor application should yield the lock screen surface of the mobile device.

18. The non-transitory computer-readable medium of claim 15, wherein the blocked message comprises a status indicator identifying the second vendor application as a current holder of the lock screen surface of the mobile device.

19. The non-transitory computer-readable medium of claim 15, wherein the completion message comprises at least one of a vendor application identifier identifying the second vendor application, a content type identifier describing content presented by the second vendor application during a period in which the second vendor application held the lock screen surface of the mobile device, or a timestamp indicating when the second vendor application relinquished the lock screen surface of the mobile device.

20. The non-transitory computer-readable medium of claim 15, wherein the instructions further cause the one or more processors to evaluate, using a machine learning model, a predicted engagement score associated with the first vendor application, wherein the request message is processed only upon the predicted engagement score satisfying a threshold value.
